(19) United States
(12) Patent Application Publication
(10) Pub. No.: US 2025/0313728 A1
(43) Pub. Date: Oct. 9, 2025

(54) HOT MELT ADHESIVES WITH HIGH RESISTANCE TO SHEAR STRESS

(71) Applicants: Savare I.C. S.r.L., Milano (IT); Rextac LLC, Odessa, TX (US)

(72) Inventors: Alberto Bugana, Milano (IT); Italo Corzani, Chieti (IT); Nick Fowler, Odessa, TX (US); Biagio Savare, Milano (IT)

(21) Appl. No.: 19/089,119

(22) Filed: Mar. 25, 2025

(30) Foreign Application Priority Data
Apr. 5, 2024 (IT) 102024000007555

(51) Int. Cl. C09J 7/35; C09J 11/08; C09J 123/20

(52) U.S. Cl. CPC C09J 7/35; C09J 11/08; C09J 123/20; C09J 2203/358; C09J 2301/304; C09J 2301/414; C09J 2301/50; C09J 2400/26; C09J 2423/00

(57) ABSTRACT

Hot-melt adhesive including from 5% by weight to 100% by weight, of at least one copolymer, comprising butene-1 and another olefin selected from C2 to C12. The copolymer has:
a Number Average Molecular Weight (Mn) greater than 3,000 g/mol;
a butene-1 content not lower than 30% by weight;
a Brookfield viscosity at 190° C. of 500 mPa·s to 100,000 mPa·s;
a Tensile Stress at Break at 45° C. after five days of aging greater than 7 MPa;
an Elongation at Break at 45° C. after five days of aging greater than 800%.
Moreover the copolymer shows also peculiar thermal properties regarding its Fusion and Crystallization Enthalpies and their DSC Peak Temperatures. The disclosed hot-melt adhesive has in particular unexpectedly good resistance to Shear Stresses.

### TECHNICAL FIELD OF THE INVENTION

The present invention relates to novel hot-melt adhesive formulations which comprise, as their fundamental polymeric component, or even as their sole polymeric component, at a level ranging from 5% by weight to 100% by weight, at least one copolymer which comprises butene-1 and at least another olefin selected from the group comprising ethene, propene and the olefins from C5 to C12. Moreover, said copolymer, which comprises butene-1, is characterized by the following basic properties:
a Number Average Molecular Weight Mn greater than 3,000 g/mol;
a butene-1 content not lower than 30% by weight and preferably not lower than 38% by weight;
a Brookfield viscosity at 190° C., from 500 mPa·s to 100,000 mPa·s;
a Tensile Stress at Break at 45° C. and after five days of aging at 23° C. and 50% Relative Humidity, that is greater than 7 MPa, as measured according to the EVF Test Method for Tensile Properties described herein;
an Elongation at Break at 45° C. and after five days of aging at 23° C. and 50% Relative Humidity, that is greater than 800%, as measured according to the EVF Test Method for Tensile Properties described herein;
an Enthalpy of Crystallization from the melt, measured at Time Zero. i.e., as defined herein, at a time not exceeding 120 minutes from the solidification of said copolymer from the molten state, that is lower than 60 J/g and that is measured according to the DSC Test Method for measuring the Thermal Properties, described herein;
an Enthalpy of Fusion, measured at Time Zero, that is greater than 10 J/g and that is measured according to the DSC Test Method for measuring the Thermal Properties, described herein;
a Peak Temperature of the main fusion peak at Time Zero that is not lower than 55° C. and that is measured according to the DSC Test Method for measuring the Thermal Properties, described herein;
a Peak Temperature of the main fusion peak, measured after five days of aging at 23° C. and 50% Relative Humidity, ranging from 55° C. and 100° C. as measured according to the DSC Test Method for measuring the Thermal Properties, described herein;
a total Fusion Enthalpy, measured after five days of aging at 23° C. and 50% Relative Humidity, from 25 J/g to 100 J/g as measured according to the DSC Test Method for measuring the Thermal Properties, described herein;
a Fusion Enthalpy detected over 100° C., measured after five days of aging at 23° C. and 50% Relative Humidity, that is not greater than 49%, and preferably not greater than 40%, of the total Fusion Enthalpy, both Fusion Enthalpies being measured according to the DSC Test Method for measuring the Thermal Properties, described herein;

In an embodiment of the present invention, the butene-1 copolymer has also a ratio between the Fusion Enthalpy, detected between 55° C. and 100° C., and the Fusion Enthalpy, detected over 100° C., that is greater than 1, both said Fusion Enthalpies being measured, after five days of aging at 23° C. and 50% Relative Humidity, according to the DSC Test Method for measuring the Thermal Properties, described herein.

In the above mentioned EVF Test Method for Tensile Properties, both the tensile stress at break and the elongation at break of the present copolymer(s) are measured by using an apparatus called EVF (Extensional Viscosity Fixture), that will be better described later, and by operating according to a method again described in details later.

Hot-melt adhesives that comprise from 5% by weight to 100% by weight of at least one of said copolymers, which comprise butene-1, show unexpectedly good properties, especially for what concerns an optimum combination between a strong adhesiveness, both on plastic films and on fibrous or porous substrates, and a surprisingly high mechanical resistance, in particular to shear stresses, a type of stresses to which often the adhesive bonds formed by the present thermoplastic adhesives are subjected in use. Said shear stresses, that can reach even very high values during the use of the articles in which the present adhesives can be utilized (e.g. in hygienic absorbent articles or inside a mattress and in its components), are especially critical for the survival of the adhesive bonds existing inside said articles between their various substrates, which substrates may be for example fibrous substrates, both woven and nonwoven ones, or plastic films, both impervious ones or porous ones or perforated films, both in a bidimensional or tridimensional way, and so on.

Said excellent resistance to shear stresses, even when these stresses are applied according to an angle which is variable with time (please see later for more details), is herewith measured according to a method called “Shear-Hang Time Test Method”, which is described below. In said test, here performed at the temperature of 38° C. (a temperature that is already per se critical for every hot-melt adhesive and that is here adopted in order to mimic the utilization of the present adhesives in articles used at the human body's temperature, e.g. hygienic absorbent articles or mattresses and their components), the hot-melt adhesives according to the present invention show a “Shear-Hang Time”, i.e. the time during which they are able to withstand shear stresses applied according to an angle which is variable during the test (which fact makes said test even more severe for the survival of said adhesive bonds), that reaches and even exceeds, after five days of aging, the exceptional value of as much as 900 seconds. Moreover, because the resistance of the present adhesives surprisingly further improves with time, these hot-melt adhesives show also a percent increase between their Shear-Hang Time at 38° C., measured according to the method herein described after 120 minutes from the solidification of the adhesive from the molten state, and their Shear-Hang Time at 38° C., still measured according to the same method, after five days of aging at Room Conditions (i.e. at 23° C. and 50% Relative Humidity) which is not lower than 10%.

In an embodiment of the present invention, said increase of the Shear-Hang Time, as expressed in its absolute value, is not lower than 300 seconds.

### BACKGROUND

Hot-melt adhesives are widely used in various fields and for manufacturing many types of articles. In particular, for example, thanks to their many advantages over other classes of adhesives, they are the choice adhesives for manufacturing hygienic absorbent articles, mattresses and their components, laminated structures used in the medical field, packages, components for the interior of vehicles and more in general components used in the automotive field, and so on.

In all these applications as well as in other ones, it is necessary that each hot-melt adhesive, that is used for manufacturing all these types of articles, shows a strong adhesion on a large variety of materials and substrates, like the already mentioned ones, which, inside those articles, can be moreover combined among them in various ways through adhesive bonds. In fact, it is obvious that a good hot-melt adhesive, besides being able to join two substrates, that can be equal or different, must also withstand all the possible types of external stresses to which the glued structures and the articles in which said glued structures are contained, are subjected during their utilization. Indeed, if a hot-melt adhesive, besides a good adhesiveness, does not have also a sufficiently high mechanical resistance to the stresses applied during the use of the article, the adhesive bond risks to get broken during said use, with the ensuing destruction of the glued structure and hence the breakdown and failure of the whole article.

As it is well known by every person who has an average knowledge in the adhesive science, in said typical uses for adhesives, the shear stresses, that can easily achieve even quite high strengths in use (e.g. for the movements of the user in the case of hygienic absorbent articles), are the type of stresses that are both the most frequently met in use as well as are also the most harmful ones for the durability of a bonded structure, especially when said shear stresses are applied, as in the test method used herein, according to a stressing angle which is not constant with time and that continuously changes during the test, as it will be better explained later while illustrating said test method.

In this regard, one can also observe that this requirement for a hot-melt adhesive of being able to withstand sufficiently high shear stresses, is not fully coincident with the sole concepts of its “hardness” or of its “cohesion”. In fact, while it is rather intuitive that an adhesive or a polymer which have a too low cohesion, i.e. which are “too soft”, with a low crystallinity and which are mechanically weak, cannot withstand sufficiently strong shear stresses, it is less intuitive the equally very negative effect that on the ability of an adhesive or polymer to withstand strong external stresses, and in particular strong shear stresses, may have an excessive hardness and crystallinity of said adhesive or polymer.

Indeed, also an adhesive or polymer which is “too hard” and too crystalline may actually totally fail in any test for withstanding strong shear stresses, because, as it is well known, a too hard material can easily break and shatter due to its excessive brittleness.

It is therefore necessary, for a certain polymeric material like the present hot-melt adhesives and the polymers that are comprised in said adhesives, to find the conditions that give an optimum equilibrium between an excellent adhesiveness on various substrates, from one side, and a sufficient strength/hardness/crystallinity of the solid adhesive; i.e. said adhesive must have neither a too low cohesion (in which case the adhesive bond would fail due to its intrinsic weakness), nor a too high hardness (in which case the adhesive might shatter due to its excessive brittleness).

On top of this, as it is well known to every person who has an average knowledge in the field of hot-melt adhesives, an excessive crystallinity can seriously impair the adhesive properties of a certain formulation, worsening its stickiness and its ability to wet the substrates that come in contact with it and impairing its ability to strongly adhere on them.

Besides this, as it is also well known, hot-melt adhesives, for being acceptable for industrial uses, must also satisfy several other requirements, like, for example, just mentioning only some of the most important ones, to have a melt viscosity that is not too high in the typical range of temperatures at which these adhesives are applied, i.e. between about 130° C. and 190° C.; an excellent processability both in slot-die coating and in spraying, even on industrial lines operating at high speed, e.g. 200 m/minute and even more; an optimum thermal stability at their high processing temperatures; a not too high cost of the adhesive formulation itself, that therefore must be based on relatively cheap polymeric ingredients, like, for example, polyolefins, and so on.

Hence, there is a need for novel hot-melt adhesives that meet in a satisfactory way all these industrial requirements, and that moreover ensure, during the utilization of the various articles that comprise said adhesives, a sufficiently good resistance to the mechanical stresses applied in use, and in particular to shear stresses.

### SUMMARY OF THE INVENTION

The problem that the present invention intends to solve is to teach how to formulate novel hot-melt adhesives that show a surprisingly strong resistance to shear stresses, even in very difficult conditions for this kind of adhesives, like in particular at a temperature as high as 38° C. (herein selected for mimicking the utilization of said adhesives inside articles that are in contact with the human body and that are therefore at its temperature) while they are still able to retain, at an excellent level, all the other fundamental properties that are typically necessary for a hot-melt adhesive, like for example:
a very good adhesiveness on various fibrous substrates, both woven and nonwoven, as well as on plastic films, both impervious and porous ones, even in the case when said films are perforated in a bidimensional or tridimensional way;
a relatively low viscosity in the molten state;
a good processability even on industrial lines running at high speed, e.g. 200 m/minute and more;
a good thermal stability even at their very high application temperatures, e.g. typically between 130° C. and 190° C., and so on.

All these problems are solved in an excellent way and all these requirements are thoroughly satisfied by hot-melt adhesives which show the characteristics of claim 1) and of the dependent claims from 2) to 34); by a bonded structure which shows the characteristics of claims 34) and 35); and by an article which shows the characteristics of claims from 36) to 43).

The other sub-claims disclose preferred embodiments. More in particular:

In a first embodiment, the present invention relates to a hot-melt adhesive characterized in that it comprises from 5% to 100% by weight of at least one copolymer, said copolymer comprising butene-1 and at least another olefin selected from C2 to C12, and also having:
a Number Average Molecular Weight Mn greater than 3,000 g/mol;
a butene-1 content not lower than 30% by weight and preferably not lower than 38% by weight;
a Brookfield viscosity at 190° C., from 500 mPa·s to 100,000 mPa·s;
a Tensile Stress at Break at 45° C. and after five days of aging at 23° C. and 50% Relative Humidity, that is greater than 7 MPa, as measured according to the EVF Test Method for Tensile Properties described herein;
an Elongation at Break at 45° C. and after five days of aging at 23° C. and 50% Relative Humidity, that is greater than 800%, as measured according to the EVF Test Method for Tensile Properties described herein;
an Enthalpy of Crystallization from the melt, measured at Time Zero. i.e., as defined herein, at a time not exceeding 120 minutes from the solidification of said copolymer from the molten state, that is lower than 60 J/g and that is measured according to the DSC Test Method for measuring the Thermal Properties, described herein;
an Enthalpy of Fusion, measured at Time Zero, that is greater than 10 J/g and that is measured according to the DSC Test Method for measuring the Thermal Properties, described herein;
a Peak Temperature of the main fusion peak at Time Zero that is not lower than 55° C. and that is measured according to the DSC Test Method for measuring the Thermal Properties, described herein;
a Peak Temperature of the main fusion peak, measured after five days of aging at 23° C. and 50% Relative Humidity, ranging from 55° C. and 100° C. as measured according to the DSC Test Method for measuring the Thermal Properties, described herein;
a total Fusion Enthalpy, measured after five days of aging at 23° C. and 50% Relative Humidity, from 25 J/g to 100 J/g as measured according to the DSC Test Method for measuring the Thermal Properties, described herein;
a Fusion Enthalpy detected over 100° C., measured after five days of aging at 23° C. and 50% Relative Humidity, that is not greater than 49%, and preferably not greater than 40%, of the total Fusion Enthalpy, both Fusion Enthalpies being measured according to the DSC Test Method for measuring the Thermal Properties, described herein.

In a second embodiment, of the present invention, the butene-1 copolymer has also a ratio between the Fusion Enthalpy, detected between 55° C. and 100° C., and the Fusion Enthalpy, detected over 100° C., that is greater than 1, both said Fusion Enthalpies being measured, after five days of aging at 23° C. and 50% Relative Humidity, according to the DSC Test Method for measuring the Thermal Properties, described herein.

In a third embodiment, the present invention relates to a bonded structure, comprising:
a first substrate;
a second substrate;
a hot-melt adhesive as in the previous embodiment, that glues the first substrate to the second substrate, which hot-melt adhesive, if applied at basis weight ranging between 0.5 g/m² and 50 g/m², gives to the glued structure a peel strength, measured after five days of aging at Room Conditions and according to the method described herein, greater than 0.25 N per 50 mm width.

Finally, in a fourth embodiment, the present invention relates to an absorbing hygienic article or to a mattress or to an automotive component or to a packaging, characterized in that said absorbing article or mattress or automotive component or packaging comprises the above described hot-melt adhesive.

### DEFINITIONS

The expressions “comprising” or “that comprise(s)” are used herein as open-ended terms, that specify the presence of what in the text follows said terms, but that does not preclude the presence of other ingredients or features, e.g. components, elements, steps, either known in the art or disclosed herein.

The expression “polymer(s)” is used herein according to the definition given in the document issued by ECHA—European Chemical Agency—edition of December 2017—and titled “How to decide whether a substance is a polymer or not and how to proceed with the relevant registration”. Hence, in the present invention we define as a “polymer” any chemical substance that contains more than 50% by weight of “polymeric molecules”; where said “polymeric molecules” are in turn defined as those molecules that contain at least three base units (monomeric ones or more complex) that are bound to a fourth unit, that can be equal or different from the first three units. Therefore, said polymeric molecules contain in total at least four base units, that can be monomeric units or more complex ones (when e.g. the base unit is, in its turn, composed by two or more monomers as it happens in condensation polymers). The expression “polymer(s)” comprises therefore both polymeric molecules formed by just one type of base units/monomer (homopolymer) as well as by multiple different types (copolymer).

In a similar way, the expression “oligomer(s)” means herein a chemical substance that contains more than 50% by weight of “oligomeric molecules”; where said “oligomeric molecules” contain less than three base units (monomeric ones or more complex) bound to another unit that can be equal or different from the first three units. Also the expression “oligomer(s)” comprises both oligomeric molecules formed by just one type of base units/monomer (homo-oligomer) as well as by multiple different types (co-oligomer).

More specifically, the expression “homopolymer(s)” is used herein according to the definition given by IUPAC (International Union of Pure and Applied Chemistry) in the article “Glossary of Basic Terms in Polymer Science”, published in “Pure and Applied Chemistry”, Vol. 68, No. 12, pp. 2287-2311, 1996. Therefore, the expression “homopolymer(s)” means herein a polymer that is synthesized from just one type of monomer.

Still according to the same reference, the expression “copolymer(s)” means in the present invention (unless it is specifically indicated a different meaning) not only a polymer in whose chemical composition are used two different monomers, but also polymers in whose chemical composition are used three, four, five or more different monomers. According to the above mentioned reference, when one wants to emphasize the number of different comonomers that constitute a certain copolymer, one can also use, as an alternative, the expressions “bipolymer”, “terpolymer”, “quaterpolymer” and so on.

“Polydispersity Index” or “Molecular Weights Distribution Index” or “PDI” refers to a measure of the distribution of the molecular weights in a certain polymer. It is also defined numerically as the ratio between the Weight Average Molecular Weight Mw, and the Number Average Molecular Weight Mn: PDI=Mw/Mn. Greater values of PDI correspond to broader distribution curves of molecular weights and vice versa. Even for compatible blends of polymers it is possible to define an average Mw, an average Mn and therefore a global “Index of Polydispersity” as defined in the case of single polymers. The Average Molecular Weights Mw, Mn and their ratio Mw/Mn=PDI, are herein measured by Gel Permeation Chromatography (GPC).

Because several polymeric materials, used in the present invention, change some of their properties (e.g. the quantity and morphology of their crystalline fraction, and hence e.g. their Enthalpies of Fusion and their mechanical properties) as a function of the time elapsed from the moment of their solidification from the molten state, in the present invention we distinguish said properties that can change with time, between “Properties at Time Zero” and “Aged Properties” at a certain number of hours or days of aging (typically five days) after the material's solidification from the molten state.

Therefore a certain property “measured at Time Zero” (for example, an Enthalpy of Fusion at Time Zero), that may be also called as an “initial” property, or a property “in the initial conditions”, means that said property is measured at 23° C. (unless a different temperature is specifically indicated) and at 50% relative humidity, and at a time that is not longer than 120 minutes from the solidification of the material under test from the molten state.

On the contrary, a certain property that is e.g. measured “at five days” or “aged at five days” or “in aged conditions”, means that said property is measured at 23° C. (unless a different temperature is specifically indicated) and at 50% relative humidity, after five days from the solidification from the molten state of the material under test. During these five days of aging the material under test is kept in a climatic room, at 23° C. and 50% relative humidity.

The expression “Room Temperature”, unless specified in a different way, means a temperature equal to 23° C.; and the expression “Room Conditions” means the conditions of an environment that is kept at the controlled temperature of 23° C. and at 50% Relative Humidity.

The expression “semi-solid” means that a specific compound or material or ingredient or their blends, are in a physical state in which, even if they have a well definite volume, they do not have a fixed own shape, and that, after some time, they take the shape of the containers that contain them. Even in the case that they are sufficiently viscous to be temporarily shaped by themselves in any tridimensional shape, after being left at rest and without any external stress, apart from their own weight, they spontaneously flow and permanently deform, so to lose rather quickly (typically in a period of time that may vary between a few seconds and about one day) their initial shape, taking the shape of the containers that contain them (if these ones were not already full to the brim) or of the solid surface on which they are lying. Therefore this definition comprises all the materials that not only may be defined as “liquid at high viscosity” according to the common meaning of this expression, but also all those materials that, in the common language, are for example defined as “creamy”, “pasty”, “jelly-like”, “fluid”, “greasy”, and the like.

The substantive “compatibility” and the adjective “compatible”, referred to the mutual blends of the ingredients of the present hot-melt adhesive formulations, and in particular to the blends of two or more polymers, are herein considered in the meaning defined in the “IUPAC. Compendium of Chemical Terminology”—2nd Edition—1997. I.e. a blend is “compatible” when it shows macroscopically uniform physical properties, independently from the fact that it is formed by “miscible” blends (i.e. that show just one Glass Transition Temperature, Tg) or by “immiscible” blends (i.e. with two or more Tg's). In particular, the present invention considers as “compatible” all those blends that, when kept in the molten state at 170° C. for 72 hours, do not show any visual de-mixing in two or more layers/phases.

The expression “hygienic absorbent article(s)” refers to devices and/or methods concerning disposable absorbing and non-absorbing articles, that comprise diapers and undergarments for incontinent adults, baby diapers and bibs, training pants, infant and toddler care wipes, feminine catamenial pads, interlabial pads, panty liners, pessaries, sanitary napkins, tampons and tampon applicators, wound dressing products, absorbent care mats, detergent wipes, and the like.

The expression “perforated films” refers to films, typically made of plastic materials like polyethylene, which are perforated with multiple holes that may have both a bidimensional or tridimensional structure and that typically have a size ranging from a few hundreds of microns to about one millimeter, which are often used as components of hygienic absorbent articles.

“Fibrous substrate(s)” refers to products having an essentially planar structure, formed by natural, synthetic or artificial fibers or their blends, both in the form of woven and of nonwoven fabrics, equally often used as components of hygienic absorbent articles.

“Open Time” of an adhesive refers, especially for a hot-melt adhesive, to the interval of time during which, after its application from the melt on a first substrate, the adhesive is able to form sufficiently strong adhesive bonds for the intended use, with a second substrate that is brought into contact under moderate pressure with the first one. It is evident that too short open times may make difficult-to-manage the application of an adhesive and the formation of sufficiently strong bonds. The open time of a holt-melt adhesive may be measured according to the test method ASTM D 4497-94, with the following conditions for the hot-melt adhesives disclosed herein:
coating temperature of the adhesive film: 170° C.
thickness of the adhesive film: 1 mm

“Ring & Ball Softening Point” or “Ring & Ball Softening Temperature” refers to the softening temperature of a thermoplastic material, measured according to the Method ASTM D 36-95. Just for waxes, the Softening Point (known in this case also as “Dropping Point” or as “Drop Melt Point”) is measured according to the Method ASTM D 3954-94.

The “Needle Penetration” of an adhesive is a measure of its softness and it is generally expressed in tenths of a millimeter (dmm). It is herein measured according to the method ASTM D1321-04.

The Dynamic Viscosity of a molten or liquid material at a certain temperature is expressed in mPa·s and it is measured according to the Method ASTM D 3236-88 (2014). In particular this Method teaches to measure the parameter that, in the technology of hot-melt adhesives, is generally referred to as the “Brookfield viscosity” of the adhesive.

The “Melt Flow Rate” or MFR of a polymeric material is generally expressed in g/10 minutes, and it is measured at 190° C. and under a weight of 2.16 kg, according to the method ISO 1133-1.

The “Tackiness” or “Tack” of a certain adhesive is herein measured according to the method ASTM D6195-03.

The overall Adhesive Strength or “Peel Strength” is defined as the average strength per unit of width needed to separate two substrates, bonded by the adhesive under test. It is measured through a separation test made at a controlled and constant speed, and under a controlled and constant detaching angle. It is herein measured according to the Method ASTM D 1876-01, separating the two substrates under a detaching angle of 180 degrees, by applying a separation speed of the two substrates equal to 150 mm/minute, that means that the testing dynamometer is actually moving at a speed of 300 mm/minute. The two substrates used herein are a polypropylene spunbonded nonwoven with a basis weight of 25 g/m², supplied by PFNonwovens (USA), on which the molten adhesive at 165° C. is directly applied at the basis weight of 4 g/m² through a slot-die coating, and to which is immediately bonded a microporous polyethylene film, with a basis weight of 15 g/m², supplied by Berry (USA).

From these bonded structure one cuts six samples with a width of 25 mm and a length of 40 mm, which samples are then aged for five days in a climatic room kept at 23° C. and 50% relative humidity. At the end of such aging, the samples are tested for their Peel Strength in aged conditions. This measurement is made by recording the strength needed for separating the two glued substrates on a width of 50 mm, according to the recommendations of the above mentioned ASTM method D1876-01, and working at 23° C. and 50% relative humidity (unless a different temperature is specified).

### Rheological Test Method

All the rheological properties of all the polymers and of the polymeric adhesive formulations disclosed in the present invention are defined and are measured according to definitions and a test method explained in the present paragraph. In particular:

The equivalent expressions “Rheological Setting Point” or “Rheological Setting Temperature” or also “Temperature of the Crossing of the Moduli” mean, in a rheological diagram in which are measured, as a function of temperature, the Viscous Modulus G″, the Elastic Modulus G′ and their ratio Tan Delta, the highest temperature at which the two Moduli cross (and in which therefore the value of Tan Delta is equal to 1) in the field of temperatures above room temperature.

In a fully similar way, when said rheological parameters are measured, still as a function of temperature, in a diagram made at increasing temperature, said crossing point of the two rheological Moduli is herein identified with the equivalent expressions “Rheological Melting Point” or “Rheological Melting Temperature”. This point where the two rheological Moduli cross and which is situated above room temperature, is often indicated with the symbol Tx. This rheological parameter as well as, more in general, all the rheological properties of a polymeric material, e.g. a hot-melt adhesive or a polymer, and in particular their Viscous Modulus G″, their Elastic Modulus G′ and their ratio Tan Delta, are herein measured according to the following method that utilizes a Ares G2 Rheometer, supplied by TA Instruments. For the rheological properties “at Time Zero” and in decreasing temperature, the sample is melted between the plates of the rheometer, by increasing the temperature to 150° C. and conditioning all the system at this temperature for 600 s. Then the measurement is started, under a stressing frequency of 1 Hz, while the temperature is decreased at the speed of 2° C./minute, until the temperature of-20° C. is reached, at which point the test is over.

For the rheological properties that are measured in increasing temperature, one follows the following method. If these properties are “at Time Zero” one again follows the above procedure already described for the case of decreasing temperature. However when the temperature of −20° C. is reached, one keeps this temperature for 600 s in order to condition the sample. Then one starts again a measurement in increasing temperature at the frequency of 1 Hz and at the speed of a temperature's increment equal to 2° C./minute, until the final temperature of 150° C. is reached.

If on the contrary one wants to measure in increasing temperature the rheological properties of polymeric materials that have been aged for five days, one first of all melts the sample at 150° C. between the two plates of the rheometer and keeps it a this temperature for 600 s, in order to condition it. Then, without recording any measurement, the sample is cooled, between the two plates of the rheometer, at the cooling speed of 2° C./minute, until the temperature of 23° C. is reached. All the system is kept at 23° C. and 50% Relative Humidity for five days. Once that this time has elapsed, one cools the sample to −20° C. and conditions it at this temperature for 600 s. Then the measurement is started, again at the stressing frequency of 1 Hz and increasing the system's temperature by 2° C. per minute, until the final temperature of 150° C. is reached, at which point the test is over.

### DSC Test Method for Measuring the Thermal Properties

The Enthalpy of Fusion, Enthalpy of Crystallization, the Glass Transition Temperature, the Peak Temperatures of the various DSC peaks of Fusion or Crystallization for all the polymers and hot-melt formulations disclosed in this invention are measured by Differential Scanning Calorimetry (DSC), according to the methods ASTM D3417-99 and ASTM D3418-12. More specifically, for measuring all these thermal properties a constant variation speed of temperature, equal to 10° C./minute, is kept, unless a different variation speed is specified. More in particular, following for all the rest the above mentioned ASTM methods, in the present invention for evaluating all the thermal parameters that are measured by DSC at Time Zero, three consecutive DSC cycles are performed, all of them at a speed of variation of the temperature equal to 10° C./minute:
1) the polymer or the hot-melt adhesive under test is heated from room temperature to 180° C. to melt it;
2) the molten material is conditioned, by keeping it in the molten state at the temperature of 180° C. for 300 s, in order to destroy the possible “memory” of all its previous thermal cycles;
3) the molten material is cooled, still at the same speed of decrease of the temperature of 10° C./minute, recording all the phenomena that may happen, like, for example, a crystallization. The cooling of the material continues even under the room temperature, until the system reaches −70° C.; this for recording also its Glass Transition Temperature Tg;
4) the material is anew conditioned by keeping it at −70° C. for 300 s;
5) then it is again heated, at the same speed of variation of the temperature equal to 10° C./minute, from −70° C. to +180° C., recording all the endothermic and exothermic phenomena that may occur.

During all these thermal cycles, the DSC apparatus is recording all the phenomena of phase change that the material undergoes (Tg, fusions, crystallizations etc.) and is also calculating for each phenomenon its intensity, by integrating the areas under the various recorded endothermic or exothermic peaks.

In particular, the Enthalpy of Crystallization and the Enthalpy of Fusion at Time Zero are expressed in J/g and are numerically given by the area (calculated through integration) of the peak or by the sum of the areas of the possible multiple peaks that are recorded, for the Crystallization at Time Zero, during the second cooling cycle from +180° C. to −70° C.; while for the Fusion at Time Zero reference is made to the overall area of all the peaks that are recorded during the third heating cycle, from −70° C. to +180° C., all said peaks being situated over the room temperature.

For evaluating all the thermal properties that are measured by DSC after five days of aging at Room Conditions, i.e. at 23° C. and 50% Relative Humidity, for example the Enthalpy of Fusion after five days of aging (which is still expressed in J/g), and for recording the relative peaks, the following procedure is followed: the adhesive or the polymer under test, at the end of its aging at 23° C. and 50% Relative Humidity for five days after its solidification from the molten state, is cooled from room temperature to −70° C. at the usual speed of variation of the temperature equal to 10° C./minute. Then one proceeds as in the previous steps 4) and 5), first by conditioning the material at −70° C. for 300 s, and then by heating it, still at the speed of variation of the temperature equal to 10° C./minute, from −70° C. to +180° C., and recording all the various detected endothermic or exothermic peaks.

When the DSC diagram of the Fusion or of the Crystallization of a certain polymeric material shows two or more peaks (possibly even partially superimposed) herein we define as “Temperature of the Fusion peak” or “Temperature of the Crystallization peak” of that material the Peak Temperature of the peak having the largest area, and hence the largest enthalpy. Said peak with the largest enthalpy is herein identified also with the expression “Main Peak”, both of fusion or of crystallization.

Other less usual parameters, measured according to specific methods, will be defined later, together with the detailed description of their measurement methods. This is valid in particular for evaluating the resistance to shear stresses, which is measured herein according to a method called “Shear-Hang Time Test Method”. This is valid also for measuring the “Tensile Properties” named also “Mechanical Properties in Tension” of all the polymeric materials disclosed herein, e.g. hot-melt formulations and polymers, like the so called “Stress-Strain Curve”, and the respective “Yield Stress”, “Peak Stress” or “Ultimate Tensile Strength”; the “Tensile Stress at Break”; the “Elongation at Break”, the “Toughness” etc. Said tensile properties are measured according to the EVF Test Method for Tensile Properties described below.

### DETAILED DESCRIPTION OF THE PREFERRED EMBODIMENTS AND OF THE MAIN COMPONENTS AND PROPERTIES OF THE ADHESIVES ACCORDING TO THE PRESENT INVENTION

### The Copolymers of Butene-1

The hot-melt adhesives according to the present invention comprise, as their fundamental polymeric component, or even as their sole polymeric component, at a level ranging from 5% by weight to 100% by weight, at least one copolymer which comprises butene-1 and at least another olefin selected from the group comprising ethene, propene and the olefins from C5 to C12. Said copolymer has also:
a Number Average Molecular Weight Mn greater than 3,000 g/mole;
a content in butene-1 not lower than 30% by weight and preferably not lower than 38% by weight;
a Brookfield viscosity at 190° C. ranging from 500 mPa·s to 100,000 mPa·s;
a tensile stress at break, measured in a stress versus elongation tensile test at 45° C. and after five days of aging at Room Conditions (i.e. at 23° C. and 50% Relative Humidity), that is greater than 7 MPa;
an elongation at break, again measured in the same experiment at 45° C. and after five days of aging at Room Conditions, that is greater than 800%.

Moreover, the inventors have surprisingly found that the present copolymers, comprising butene-1, possess also a few fundamental and very peculiar thermal properties, as e.g. detected in the DSC diagrams of their Crystallization or Fusion analyses, both at Time Zero and after five days of aging at 23° C. and 50% Relative Humidity. These fundamental and very peculiar thermal properties will be illustrated below, in the final section of the present paragraph.

The present hot-melt adhesives, which comprise at least one copolymer comprising at least 30% by weight and preferably at least 38% by weight or more of butene-1 and which have also the above described properties, show, in addition to an excellent adhesion on various substrates, like plastic films, both perforated and unperforated, or fibrous substrates, both woven and nonwoven and made of various types of fibers both natural, synthetic or artificial ones, also an unexpectedly strong resistance of the adhesive bonds that they create between said substrates, to many types of mechanical stresses, and especially to shear stresses, even when these stresses are applied according to angles that change with time during the use, which fact, as it will be better explained below, makes these stresses particularly severe and harmful for the durability of the bonded structure.

The present hot-melt adhesives are therefore especially suitable for very critical uses, not only thanks to their excellent adhesive properties, but also, and somehow even more, for their surprisingly good properties of mechanical resistance to strong shear stresses, which properties allow their use as choice adhesives e.g. in manufacturing hygienic absorbent articles or mattresses and their components or other similar quite critical uses.

In fact, as it is well known to every person who has an average knowledge in the science of adhesives, in all these typical uses for an adhesive, the shear stresses, that in use may reach even very high strengths (for example due to the movements of the user in the case of hygienic absorbent articles), are the type of stresses that not only are the most frequent ones in use but that also are the most dangerous and harmful ones for the durability of an adhesively bonded structure. This is even truer in particular when said shear stresses are applied, as in the test method used herein, according to a stressing angle that is not constant and that continuously changes during the test, as it will better explained later in describing said peculiar test method, which is herein called Shear-Hang Time test.

This test, in order to mimic in the best way the particularly critical conditions of use that the adhesives according to the present invention meet inside articles like the above mentioned ones, is not only performed at the temperature of 38° C. (temperature used herein for simulating the use in contact with a human body) but it also applies a stressing angle for the shear stress that changes in a continuous way during said test, as it actually happens in the real use of the aforementioned articles.

This allows said test to try the tested adhesives at the same time both for their adhesiveness as well as for their resistance to particularly tough shear stresses. This characteristic makes said very severe Shear-Hang Time test different from all the other usual tests that are generally separately used for measuring the adhesive strength of an adhesive in a detachment according to a defined and constant angle or its resistance to a shear stress applied again according to a defined and constant angle, like, for example, it happens in the so called standard Peel Strength Test performed according to the method ASTM D1876-01 or in the so called standard Shear Strength test according to the method ASTM D3654-02.

The choice and utilization of butene-1 as the essential monomer for the present copolymers, that constitute the main, or even the sole, polymeric component of the hot-melt adhesives according to the present invention, as well as the high content of this monomer (not lower than 30% by weight and preferably not lower than 38% by weight) in these copolymers, is due to the outstanding properties that homopolymers and copolymers of butene-1 show in the development, in their solid state, of a very peculiar kind of polymeric crystallinity that is not only particularly robust but that also is further slowly evolving with time, both in a qualitative and quantitative way, after the solidification of the polymeric material from the molten state.

The ability of butene-1 polymers, both homopolymers and copolymers, especially when they are in their isotactic form, to slowly crystallize in the solid state in a way that is fully different from the one of all the other main polyolefins, is widely known. This peculiar characteristic was noticed since the synthesis of the first lab samples of this polymer in 1954 by its discoverer, the Nobel Prize Giulio Natta.

While all the other polyolefins that may crystallize, like e.g., polyethylene or isotactic polypropylene, when they solidify from the melt, reach in a very quick and often in a practically instantaneous way the final crystalline structure and the final level of crystallinity that they can reach according to their specific molecular morphologies, butene-1, inside its homopolymers and copolymers, crystallizes in a totally different way.

A thorough illustration of these peculiar properties in the crystallization of butene-1 homopolymers and copolymers can be found e.g. in the article “Polymorphic Behavior and Phase Transition of Poly(1-Butene) and its Copolymers” by R. Xin, J. Zhang, X. Sun, H. Li, Z. Ren, S. Yan published in Polymers (Basel), 10(5): 556 (May 2018); or in the article “Differential Polymorphic Transformation Behavior of Polybutene-1 with Multiple Isotactic Sequences” by Y.P. Ma, W.P. Zheng, C.G. Liu, et al. published in Chinese Journal of Polymer Science, 38, 164-173 (2020); or in the article “Crystallization and Transformation of Polybutene-1” by M. Hribova e F. Rybnikar published in Journal of Macromolecular Science-Part B Physics-43(5): 1095-1114 (2005); or in the doctorate dissertation “The Crystallization Behaviour of Isotactic Polybutene-1” by H. B. Erdem published in August 2002 by the Bilkent University.

Without entering now into a detailed discussion of said peculiar crystallization behavior of the butene-1 polymers, here we can concisely say the following: it is reasonable to think that the particular molecular crystalline structure of the chains and of the chain's segments of isotactic polybutene-1, which is formed by a close series of C2 side groups, that are relatively long and sterically bulky, and are one near the other, makes much slower the formation of crystalline regions, compared to what it happens for example in the case of polypropylene and of polyethylene. However its very ordered structure, as well as the helicoid spatial conformation that the chains and the chain's segments of isotactic polybutene-1 tend to take, lead this polymer and its copolymers to generate, after a certain time, a percent content of crystallinity that is significantly greater than in other polyolefins as well as to develop final mechanical properties that are considerably stronger. Said process of growth of a slower, greater and stronger crystalline structure of polybutene-1 is further favored by the polymorphism of this polymer that shows as many as three different possible crystalline forms. One of these crystalline forms, called “Form III”, is generated only from solution and hence it cannot appear in the hot-melt formulations of the present invention. A second crystalline form, called “Form II” with a tetragonal structure, is generated first, when polybutene-1 and its copolymers and formulations solidify from the molten state, as it happens with the present thermoplastic adhesives. Both these two crystalline forms are unstable, and they slowly transform, in the solid state and at room temperature, into a hexagonal stable form, called “Form I”, which has a melting point and mechanical properties that are both significantly greater.

Therefore, the copolymers of butene-1, comprised in the hot-melt adhesives according to the present invention as well as these adhesives themselves, show, after their solidification from the molten state, a “time-delayed crystallization” that changes, both in a quantitative and qualitative way, their crystallinity and that completes in a few days, approximately from about three to about seven days, and typically in about five days. This phenomenon of “time-delayed crystallization” in polybutene-1 is consequently a really very complex phenomenon that, besides the slow generation and growth of new crystals, includes also the slow transformation of the tetragonal “Form II” crystals (that as said are thermodynamically unstable and that have been initially generated when the polymeric material has solidified from the molten state) into the stable hexagonal “Form I” crystals, that are also significantly stronger and more resistant, both mechanically and thermally. Said crystalline growth and transformation at room temperature of the butene-1 copolymers and of the present hot-melt adhesives, that comprise them, are the causes of dramatic changes with time in the thermal, mechanical, rheological and adhesive properties of the hot-melt adhesives disclosed herein. Their properties, that are already good just after their solidification from the molten state, further improve with time thanks to these phenomena, while these delayed crystallization and crystalline transformation progress both quantitatively and qualitatively.

Consequently, as already mentioned, for the present copolymers of butene-1 and for the hot-melt adhesives in which they are comprised, it is necessary, in measuring their thermal, mechanical, rheological and adhesive properties, to distinguish between “properties measured at Time Zero”, i.e. just immediately after their solidification from the molten state, or in a more practical way, as herein defined, measured within no more than 120 minutes from their solidification from the molten state; and on the contrary properties measured after the completion of the crystalline transformation and additional crystalline growth of polybutene-1, i.e. after five days of aging at the Room Conditions of 23° C. and 50% Relative Humidity.

The inventors of the present invention have surprisingly found that copolymers which comprise at least 30% by weight and preferably at least 38% by weight of butene-1, copolymerized with at least another olefin, selected from the group from C2 to C12, and which also have the other auxiliary properties, as defined at the beginning of the present paragraph and in the claim 1) of the present patent, are able to generate hot-melt adhesives with exceptionally good characteristics, both for what concerns their excellent adhesiveness as well as their very high mechanical resistance, in particular to strong shear stresses.

About this point, it is opportune to highlight that said peculiar time-delayed crystallization ensures first of all a strong adhesion on various substrates, both impervious ones, like, for example, unperforated plastic films, as well as on substrates with an uneven surface, like porous or perforated films, or fibrous substrates, either woven or nonwoven. In fact, the copolymers of butene-1 and the hot-melt adhesives comprising them, according to the present invention, at Time Zero, i.e. immediately after their extrusion in the molten state, form a mainly amorphous mass with a quite low crystallinity, a soft and tacky mass which wets very well the great majority of substrates, in this way generating strong adhesive bonds. In addition, their initial softness and low crystallinity allow the semi-solidified adhesives to flow and even partially penetrate inside pores or holes or spaces of porous, perforated and fibrous substrates, in this way further increasing the adhesive strength. Moreover, the quantitative increase of the polybutene-1 crystallinity and the simultaneous morphological transformation of the polybutene-1 crystals from Form Il to Form I (that as said is more robust both thermally and mechanically), during on average the following five days, give to the hot-melt adhesives disclosed in the present invention an exceptional mechanical resistance even to the strongest and most severe stresses, as in particular to shear stresses, even when they are applied according to angles that are not constant and that change with time.

It is eventually also opportune to observe that, for what said above, also the homopolymers of isotactic polybutene-1 might be quite interesting components of the hot-melt adhesives disclosed herein. However, the inventors have found that the homopolymers of isotactic polybutene-1 can easily reach a too high percent content of crystallinity in the Form I of polybutene-1. In fact, even if these homopolymers are generally very strong materials, especially when they are subjected to tension stresses, thanks to their very high Form I crystallinity, they can also be (like several “too hard” materials) somehow fragile and brittle. This brittleness may make them unable to adequately withstand without failing strong shear stresses, especially when these stresses are applied according to angles that continuously vary. In addition, as already mentioned, their tendentially quite high crystallinity can, at least partially, impair their adhesive properties. Therefore, said homopolymers of polybutene-1 are not a preferred embodiment as basic polymers in the formulation of the hot-melt adhesives according to the present invention. However, they can be used, as e.g. claimed in the below claim 17) of the present patent, as additional polymeric ingredients, optionally present in minor quantities, in formulating the hot-melt adhesives disclosed herein.

Moreover the copolymers of butene-1, comprised in the present hot-melt adhesives, have, after five days of aging at 23° C. and 50% Relative Humidity, and hence after having completed the time-delayed crystallization of their chain segments of polybutene-1, a total Fusion Enthalpy ranging from 25 J/g to 100 J/g, which enthalpy is significantly lower than the correspondent fusion enthalpy of the pure isotactic polybutene-1. These values of fusion enthalpy indicate that in these polymeric material there is a crystalline content that is sufficiently high to guarantee excellent mechanical properties, without being however so high to impair their adhesiveness or to make them brittle due to an excessive hardness. In other words, this suggests that the copolymerization between butene-1 and one or more other olefins selected from the group from C2 to C12, generates, inside the present copolymers and inside the adhesives comprising said copolymers, an optimum balance between a crystalline phase and an amorphous phase, which both favors a strong adhesiveness on various substrates and also makes the material not too hard and brittle.

This is visible also in the thermal behavior of these polymeric materials at Time Zero, i.e. in the moment when the hot-melt adhesives comprising said butene-1 copolymers create the adhesive bonds with various substrates, while solidifying from the molten state. In fact, in the DSC cycles, in cooling and in heating, at Time Zero, the present butene-1 copolymers show a Crystallization Enthalpy (and so an immediate content of crystallinity just after their solidification from the molten state) that is rather low, and more precisely is lower than 60 J/g, which fact allows the creation of strong adhesive bonds. However, at the same time, this overall initial crystallinity, measured through the Fusion Enthalpy again at Time Zero, cannot be too small, in order to ensure, since the very first moment, a sufficient robustness of their adhesive bonds inside all the articles in which the present adhesives are utilized. Indeed, the butene-1 copolymers disclosed herein have at Time Zero a Fusion Enthalpy (and so a correspondent minimum initial content of crystallinity) that is greater than 10 J/g.

As previously anticipated, the inventors have also surprisingly found that a few peculiar thermal characteristics in the DSC melting diagram, measured after five days of aging at Room Conditions, of the butene-1 copolymers disclosed in the present invention, are particularly and unexpectedly important for giving to the hot-melt adhesives, that comprise said copolymers, an excellent adhesiveness combined with an optimum mechanical resistance to severe shear stresses. Therefore, the butene-1 copolymers disclosed herein show in particular, in the melting DSC diagram, measured after five days of aging at 23° C. and 50% Relative Humidity:
a Peak Temperature of the main fusion peak having a value between 55° C. and 100° C.;
a percentage of the fusion enthalpy detected over 100° C. that is not greater than 49% of the overall measured fusion enthalpy, preferably not greater than 40% of the overall measured Fusion Enthalpy;

Moreover, in a second preferred embodiment, the butene-1 copolymers disclosed herein show also, in the melting DSC diagram, measured after five days of aging at 23° C. and 50% Relative Humidity, a ratio between the Fusion Enthalpy, detected between 55° C. and 100° C., and the Fusion Enthalpy, detected over 100° C., that is greater than 1.

It has been therefore surprisingly discovered that the best properties, both as adhesiveness and as mechanical resistance to shear stresses, of the hot-melt adhesives in which the aforementioned butene-1 copolymers are comprised, are obtained when said copolymers have a crystallinity that is balanced, both in a quantitative and qualitative way, and when said crystallinity, for its compositional and morphological characteristics, substantially melts mainly in the temperature range from 55° C. to 100° C.

In particular, it has been also, even more surprisingly, discovered that the fraction of crystallinity of these copolymers which, for compositional and morphological reasons, melts over 100° C., and that therefore is reasonably formed e.g. of substantially pure crystals of the Form I of isotactic polybutene-1, must be present in a controlled and limited quantity. This inference, given the high thermal and mechanical resistance of said type of Form I crystals, may seem a contradictory conclusion. On the contrary, without being for this linked to any specific theory, it seems reasonable to think that e.g. an excessive quantity of crystals with a high melting point (i.e. crystals mainly of the Form I of polybutene-1) makes the material too hard and hence too brittle, and so not sufficiently able to withstand strong shear stresses because of its too high hardness and fragility. Additionally, it seems also reasonable to suppose that an excessive amount of said crystalline Form I, having a high melting point and a high hardness, may cause a partial de-mixing of this phase from the rest of the adhesive mass, due to its poor compatibility with the other amorphous phase. This partial de-mixing may lead to a surfacing of this hard and brittle crystalline fraction on the outer layer of the adhesive, directly in contact with the substrates, in this way seriously impairing the tackiness and the adhesive properties of the overall hot-melt formulation.

### Peculiar Characteristics in the Synthesis Process of the Present Butene-1 Copolymers

The above described butene-1 copolymers can be synthesized both utilizing metallocene catalytic systems or Ziegler-Natta catalytic systems.

In particular, when Ziegler-Natta catalytic systems are used, the synthesis process of these butene-1 copolymers must preferably satisfy a few peculiar characteristics. More specifically the synthesis of these copolymers, comprising butene-1, is carried out in a stirred reactor and with the following conditions:
at a temperature from 50° C. to 90° C., preferably from 60° C. to 80° C., and at an absolute pressure from 1.5 MPa to 3.0 MPa;
with an average residence time of reactants inside the stirred reactor from 60 minutes to 180 minutes and preferably from 90 minutes to 150 minutes;
in the presence of an electron donor in a sufficient quantity such that the molar ratio of the electron donor to the tri-alkyl-aluminum co-catalyst, used in the Ziegler-Natta catalytic system, is in the range from 1:100 to 1:10, preferably from 1:60 to 1:20. Said electron donor is preferably an alkoxy-silane, selected from the group consisting of cyclohexyl methyl dimethoxysilane, phenyl triethoxy silane, dimethyl diethoxy silane, dodecyl triethoxy silane, methyl phenyl diethoxy silane, dimethyl diisopropenoxy silane, methyl octyl dimethoxy silane and methyl triethoxy silane.

### Futher Main Embodiments of the Present Inventions

In a third embodiment of the present invention, the butene-1 copolymers, that are comprised in the hot-melt adhesives disclosed herein, comprise, besides at least 30% by weight, and preferably at least 38% by weight of butene-1, also from 25% to 70% by weight of propene, preferably from 50% by weight to 62% by weight of propene.

In a fourth embodiment, the butene-1 copolymers disclosed herein, comprise from 2% by weight to 30% by weight of ethene or of hexene.

In a fifth embodiment, the butene-1 copolymers disclosed herein show, in an experiment of Stress-Elongation to break, performed at 45° C. after five days of aging at 23° C. and 50% Relative Humidity, and measured according to the EVF Test Method for Tensile Properties described below, a Toughness greater than 5.0 MJ/m^{3.}

In a sixth embodiment, the hot-melt adhesives according to the present invention comprise, besides the above described butene-1 copolymers, also from zero to 40% by weight of at least one additional polymer or of a mixture of additional polymers, that can be both homopolymers or copolymers, and that individually comprise less than 38% by weight of butene-1, and preferably less than 30% by weight of butene-1. Said additional polymers can be synthesized both by using metallocene catalysts or Ziegler-Natta catalysts.

In a seventh embodiment, the above mentioned additional polymer (homopolymer or copolymer) or at least one polymer in said mixture of additional polymers, comprising less than 38% by weight and preferably less than 30% by weight of butene-1, comprises zero butene-1.

In an eighth embodiment, said additional polymer or at least one polymer in the mixture of additional polymers, comprising less than 38% by weight and preferably less than 30% by weight of butene-1, is a polyolefin selected from ethene homopolymers or propene homopolymers; copolymers of ethene and propene, also with a heterophasic structure; copolymers between ethene or propene and an alpha olefin from C5 to C12; copolymers between propene and ethene and an alpha-olefin from C5 to C12; or it is selected from styrenic block copolymers; or from mixtures between the mentioned polyolefins and styrenic block copolymers.

In an ninth embodiment, as already partly described, said additional polymer or at least one polymer in the mixture of additional polymers, which can be present in the herein disclosed hot-melt adhesives at a content from zero to 40% by weight, is on the contrary constituted by a homopolymer of polybutene-1 or by a mixture of homopolymers of polybutene-1.

In a tenth embodiment, the additional polymer or at least one polymer in the mixture of additional polymers, which is/are present in a content from zero to 40% by weight in the herein disclosed hot-melt adhesives, as in any one of the preceding embodiments, is modified with at least one functional group, like, for example, maleic anhydride, maleic acid, acrylic or methacrylic acid, esters of acrylic or methacrylic acids, vinyl acetate and so on.

In general the sum of all the polymers comprised in the hot-melt adhesives according to the present invention constitutes from 5% by weight to 100% by weight of the overall adhesive formulation.

In the following paragraphs, more detailed information is given about possible additional ingredients, not yet mentioned so far, of the present hot-melt adhesives.

### Additional Ingredients

The present hot-melt adhesives can also comprise other additional ingredients. In particular:

### Tackifiers

In a further embodiment of the present invention, the hot-melt adhesive formulations disclosed herein comprise also from zero to 95% by weight of a tackifier or of a mixture of tackifiers. Said tackifier or mixture of tackifiers has a Ring & Ball Softening temperature ranging from 5° C. to 160° C., and preferably not lower than 70° C.

In a further embodiment, this tackifier or mixture of tackifiers has a Ring & Ball Softening temperature that is not lower than 90° C., preferably not lower than 100° C. and even more preferably not lower than 110° C.

Said tackifier or mixture of tackifiers is selected from non-hydrogenated, partially hydrogenated or fully hydrogenated aliphatic or cycloaliphatic hydrocarbon resins; non-hydrogenated, partially hydrogenated or fully hydrogenated aromatic hydrocarbon resins; non-hydrogenated, partially hydrogenated or fully hydrogenated aliphatic/aromatic or cycloaliphatic/aromatic hydrocarbon resins; non-hydrogenated, partially hydrogenated or fully hydrogenated polyterpene or modified polyterpene resins; non-hydrogenated, partially hydrogenated or fully hydrogenated rosins and esters thereof; and mixtures thereof.

Partially and fully hydrogenated tackifiers, both aliphatic or cycloaliphatic, aromatic and aliphatic/aromatic or cycloaliphatic/aromatic ones, are especially preferred because of their excellent compatibility with the butene-1 copolymers, comprised, as their main polymeric components, in the hot-melt adhesives disclosed herein.

### Plasticizers

In an additional embodiment of the present invention, the hot-melt adhesives disclosed herein comprise also from zero to 40% by weight of at least one liquid or semi-solid plasticizer or of a mixture of liquid or semi-solid plasticizers. Said liquid or semi-solid plasticizer or mixture of liquid or semi-solid plasticizers is selected from paraffinic mineral oils or naphthenic mineral oils and mixtures thereof; liquid or semi-solid paraffinic and naphthenic hydrocarbons, and mixtures thereof; liquid or semi-solid oligomers and polymers of olefins from C2 to C20 and liquid or semi-solid co-oligomers and copolymers thereof; liquid or semi-solid plasticizers consisting of esters, such as phthalates, benzoates, sebacates, citrates, tartrates; vegetable oils; liquid or semi-solid natural and synthetic fats; and mixtures thereof.

In a sub-embodiment, the above-mentioned liquid or semi-solid oligomers and polymers of olefins from C2 to C20 and their liquid or semi-solid co-oligomers and copolymers are synthesized with metallocene catalytic systems or have anyhow a Polydispersity Index lower than 3.5 and preferably lower than 2.5. Similar plasticizers are manufactured and sold e.g. by ExxonMobil under the trade marks SpectraSyn and Elevast; by Ineos under the trade mark Durasyn; by Chevron Phillips under the trade mark Synfluid; by Clariant under marks like Licocene PPA 330.

### Waxes

In a further embodiment of the present invention, the hot-melt adhesives disclosed herein comprise also at least one wax or a mixture of waxes at a content ranging from zero to 15% by weight, preferably from zero to 10% by weight and even more preferably from zero to 5% by weight.

In a subsequent embodiment, said wax or at least one wax in the mixture of waxes is a polyolefinic wax, and in particular a polyolefinic wax that comprises more than 50% by mole of ethene or of propene.

In an additional embodiment, said wax or at least one wax in the mixture of waxes is modified with maleic anhydride.

Eventually, in a final embodiment, said wax or at least one wax in the mixture of waxes, comprised in the hot-melt adhesives disclosed in the present invention, has a melting temperature that is not lower than 90° C.

### Other Optional Ingredients

The hot-melt adhesives according to the present invention can furthermore comprise from zero to 10% by weight of at least one stabilizer or of a mixture of stabilizers, like, for example, antioxidants, anti-UV photo-stabilizers, and mixtures thereof.

The present hot-melt adhesives can moreover comprise from zero to 10% by weight of other optional additional ingredients, like, for example, mineral fillers, pigments, dyes, perfumes, surfactants, antistatic agents, and mixtures thereof.

### Other Basic Properties of the Hot-Melt Adhesives According to the Present Invention

The novel hot-melt adhesives disclosed herein show moreover the following physical and rheological properties:
a Brookfield viscosity, measured at 190° C., that is not greater than 20,000 mPa·s, preferably is not greater than 15,000 mPa·s and more preferably is not greater than 10,000 mPa·s;
a Ring & Ball Softening Temperature that is not greater than 135° C. and preferably is not greater than 120° C.;
after five days of aging at Room Conditions, i.e. at 23° C. and 50% Relative Humidity, they show a Rheological Melting Temperature Tx, measured in increasing temperature at the frequency of 1 Hz and at the heating rate of 2° C./minute, that is not lower than 80° C.;
again after five days of aging at Room Conditions, they show an Elastic Modulus G′ at 38° C., measured in increasing temperature at the frequency of 1 Hz and at the heating rate of 2° C./minute, that is not lower than 0.5 MPa.

### Shear-Hang Time Test Method

As already mentioned, the hot-melt adhesive formulations according to the present invention show at the same time an excellent adhesiveness and a very strong resistance to external mechanical stresses, both properties significantly and surprisingly improved compared to the previous state of the art. Said combination between excellent adhesiveness and very strong mechanical resistance allows the present adhesives to be utilized in particularly severe uses, for example in the laminated structures that constitute the impermeable outside layer of a baby diaper or various glued components inside a mattress, applications in which the majority of other hot-melt adhesives, that seem apparently similar, fail in use.

As already highlighted, the particular severity and difficulty of said applications derives from the fact that e.g. the mentioned laminated/glued structures are subjected, during their use, to multiple stresses (and especially shear stresses) which not only can be even quite strong in absolute value but which also are mostly applied according to stressing angle that continuously change, during the use, between zero and 180 degrees. Therefore it doesn't make much sense and it doesn't adequately mimic the particularly severe conditions of actual use the fact of separately testing a certain adhesive for its adhesive properties and for its properties of mechanical resistance to shear stresses, as it's generally done in the great majority of the prior art. In fact, in the great majority of said prior art, the testing of an adhesive is normally done by separately testing from one side its adhesive properties through the so called Peel Strength; and, from the other side, by independently testing the adhesive's strength and cohesion, through the so called Shear Strength. Both these two independent tests are performed according to application angles of the stress which are fixed and constant during the whole time of the test.

For example, the Peel Strength, that is defined as the average strength per unit of width needed to separate, at a constant speed and under a constant detaching angle, two substrates glued by the tested adhesive, is generally measured according to the method ASTM D 1876-01, i.e. keeping a constant angle for applying the detaching strength that is equal to 90 degrees or alternatively to 180 degrees. In a similar way, the Shear Strength is generally measured according to the method ASTM D 3654-02, in which one measures the time needed for detaching from a rigid vertical substrate (for example a vertical steel panel) a substrate glued to the vertical panel by the tested adhesive. In this case the detaching of the glued substrate from the vertical steel panel is caused by a perfectly vertical constant strength, i.e. by a stress that is applied according to a fixed and constant angle, which in the specific case is equal to zero degrees, for example the load of a hanging fixed weight attached to the glued substrate.

Therefore, both these two test methods give two fully separate and independent measures of the adhesiveness and of the cohesion/mechanical resistance of the tested adhesive, measured according to stressing angles that in all cases are constant during the whole time of the tests, as said generally 90 degrees or 180 degrees for the adhesiveness, and zero degrees for the mechanical shear resistance.

On the contrary, as it is well known by any person who has even just an average knowledge in the science and technology of adhesives, in particularly severe applications, in which the stressing angle of the applied stress is continuously changing, the overall behavior of the adhesive, in its components of adhesion and cohesion/mechanical resistance, is a really long way from being expressed by a mere sum of its Peel Strength and of its Shear Strength, that are both measured independently one from the other, using during the test fixed and constant angles, which angles by the way are different, as shown above, in the two used test methods.

Already other inventors, who dealt with hygienic absorbent articles and with the glued structures used inside those articles, have highlighted the unsuitability and the inadequacy of the two independent tests of Peel Strength and of Shear Strength for measuring, in conditions that are closer to the real use, the overall resistance of said glued structures, especially in the most severe uses, like, for example, in the outside impermeable layer of a baby diaper.

For testing the overall resistance of said bonded structures in these particularly tough uses, it has been proposed a different type of test, much more severe, in which the glued structure, intended to be utilized inside a hygienic absorbent article, is subjected at the same time to a stress of Peel and to a stress of Shear, moreover according to an angle that is continuously changing during the test, in a very similar way to what it actually happens during a real use.

In the industrial and patent technological jargon, this much more severe test is called with various different names, like “Shear-Hang Time” or “Hang Test” or “Hang Time Test” or “Peel Hang Time Test” and so on, even if, for what has been said, this test method must not be confused either with a standard test of pure peel according to ASTM D 1876-01, or with a standard test of pure shear according to ASTM D 3654-02.

An example of the use of this severe “Hang Test” o “Peel Hang-Time Test”, utilized for testing the adhesive and mechanical resistance of laminated glued structures to be used inside a baby diaper, is e.g. given in the patent US 9 084 699.

In general, this test measures the time that is needed for detaching and opening a certain fixed area of a glued structure (laminate), when a fixed weight is hung from one of the two substrates of said laminated structure and this loaded structure is allowed to freely dangle under the stress given by the weight. This Shear-Hang Time test is different from the standard Shear Test described in ASTM D 3654-02 especially because in the Shear Test the weight is stressing the glued structure in a way that is rigorously parallel to the vertical direction, i.e. according to a stressing angle that is constantly zero degrees during the whole test; while, as said, in this Shear-Hang Time test both the two substrates, forming the glued structure, are freely dangling.

Therefore, the angle according to which the weight, hanging from one of the two substrates, is stressing the adhesive is not constant and fixed a priori. This angle is dependent on the spatial angular position that the specific two substrates assume while freely dangling under the weight's action, hence depending also on their own stiffness. Furthermore, said angle is continuously changing with time, during the test, as the two substrates gradually and slowly detach one from the other and the laminate opens under the action of the hanging weight, that therefore is causing at the same time a stressing action both in peeling as well as in shearing.

More specifically, in the present invention the Shear-Hang Time test is performed in the following way: on a pilot line for the processing and application of hot-melt adhesives, it is manufactured a glued structure (laminate) constituted by a polyethylene film, with a basis weight of 15 g/m² available from Berry (USA), and by a spunbonded polypropylene nonwoven, with a basis weight of 25 g/m² available from PFNonwovens (USA).

The gluing of the two substrates is made through a slot-die extrusion of the molten adhesive under test, at the temperature of 165° C. and at the basis weight of 4.0 g/m² on said pilot line that is running at the speed of 400 m/minute and that well mimics the operating conditions of an industrial line for manufacturing hygienic absorbent articles. The molten adhesive is applied on the nonwoven because the polyethylene film might deform or form holes when in direct contact with the molten adhesive. After the application, the nonwoven is immediately put in contact with the plastic film and the two substrates adhere one on the other.

If one wants to measure the Shear-Hang Time of the tested adhesive “in the initial conditions” or “at Time Zero”, i.e. as previously defined at a time that at most is not longer than 120 minutes from its solidification from the molten state, the below described test is performed as soon as possible and in any case within at most two hours after the moment in which the laminated structure has been created.

If on the contrary one wants to measure the Shear-Hang Time of the adhesive after five days of aging (a measure that is certainly more significant for the final performances in use of the adhesive) the laminated structure, manufactured as explained above, is stored and aged for five days inside a climatized room kept at 23° C. and 50% Relative Humidity. Once that this aging time has elapsed, one cuts from each laminate six rectangular strips, each having a width of 100 mm and a length of 90 mm. Each strip is tested in a closed environment kept at 38° C. in the following way: the strip is partially opened at one of its 100 mm wide ends, by detaching the two substrates and opening them for a length of 50 mm.

One marks, with a transversal line drawn with a black indelible pen, the beginning of the part of the laminate that is still glued.

Afterwards, the open end of the polyethylene film is attached at its terminal part, through a small clamp, to a fixed metallic support, that is placed at a height of at least 500 mm over the floor or over the supporting surface. On the contrary, the other open end of the nonwoven is spread apart, bending it outwards in the direction opposite to the plastic film, and it is allowed to freely dangle. At that dangling end of the nonwoven one attaches, again though a small clamp, a weight such as the overall load (clamp plus weight attached at the freely dangling end of the nonwoven) is exactly equal to 150 g.

All the system is allowed to freely dangle and the chronometer is started. Under the action of the weight, the detachment and opening of the laminate start and go on, with a simultaneous action of peeling and shearing. The chronometer is stopped when the weight and the nonwoven detach and fall, recording the elapsed time in seconds. The test is repeated on six identical samples of the same laminate. The Shear-Hang Time for the tested adhesive is calculated as the average value of the times recorded for the six samples.

The hot-melt adhesive formulations according to the present invention show values of Shear-Hang Time at 38° C. and after five days of aging at 23° C. and 50% Relative Humidity, not lower than 900 seconds. Moreover, because the resistance to shear stresses of the present adhesives surprisingly and significantly improves with time, the hot-melt adhesives disclosed herein show also a percent increase between their Shear-Hang Time at 38° C., measured according to the herein described method, after 120 minutes from their solidification from the molten state, and their Shear-Hang Time at 38° C., measured still according to the same method, after five days of aging at Room Conditions, which is not lower than 10%.

Furthermore, in an embodiment of the present invention, said increase of the Shear-Hang Time with the time elapsed from the solidification of the present hot-melt adhesives from the molten state between two hours and five days, is in absolute value not lower than 300 seconds.

### EVF Test Method for Measuring the Tensile Properties

The tensile properties, called also “mechanical properties in tension”, of a certain material, for example a polymer or an adhesive formulation, such as their Stress-Strain curve (or their “Stress-Elongation to Break” curve) and the respective “Yield Stress”, “Peak Stress” or “Ultimate Tensile Strength”; the “Tensile Stress at Break”; the “Elongation at Break”, the “Toughness” etc. are herein measured at 45° C. and 50% Relative Humidity, according to the EVF test method described below. Said temperature of 45° C., that is very severe for every thermoplastic material like the polymers and adhesives disclosed in the present invention, has been herein chosen for stressing and differentiating at the maximum level the tensile properties of the polymers and adhesives used herein and for mimicking even conditions of use that can be extremely tough for the hot-melt adhesives in which said polymers are comprised, for example their possible utilization in tropical climates.

As it is well known, in a Stress—Elongation to Break curve of a certain material, the Toughness is numerically expressed by the whole area (calculated by integration) subtended by said Stress—Elongation to Break curve, It expresses the specific energy needed for mechanically breaking said material and it is expressed in MJ/m^{3.}

The tensile properties and in particular the Stress—Elongation to Break curve are herein measured by using a rotational rheometer Ares G2, supplied by TA Instruments, which is equipped with an accessory tool named Extensional Viscosity Fixture (EVF). The rheometer is also equipped with a controlled temperature space (FCO) that allows to perform tests at a controlled temperature between −50° C. and +250° C.

For measuring and recording the Stress—Elongation to Break curve, the tested polymer or adhesive is extruded, by a lab coater for thermoplastic materials, at the temperature of 170° C. on siliconized paper in the form of a continuous strip with a width of 50 mm and a thickness of 0.2 mm. For measuring the tensile properties in aged conditions, the extruded strip of the polymer or adhesive is aged for five days in a climatized room kept at 23° C. and 50% Relative Humidity. After this aging, for each tested polymer or adhesive, one cuts from said continuous strip of aged materials the samples, each with a length of 100 mm, that are then tested with the EVF apparatus at the temperature of 45° C. and at the rotation frequency of the straining roll equal to 0.01 turn/second. In this way the apparatus records and draws the various Stress—Elongation to Break curves and calculates the respective various tensile parameters.

### Comparative Example 1

The following comparative hot-melt adhesive has been formulated by using, as its main polymeric component, a butene-1—propene copolymer that does not satisfy the requirements of the present invention. It has been prepared by mixing its constituents in the molten state at 170° C.:

| | % by weight | |
|---|---|---|
| | on the total | |
| | weight of | |
| | the adhesive | |
| Ingredient | formulation | Nature and supplier |
| Rextac RT2730 | 64.7 | C3-C4 Ziegler-Natta copolymer |
| | | supplied by Rextac (USA) |
| Licocene PP 1602 | 10.0 | C3-C2 metallocene copolymer |
| | | supplied by Clariant (Switzerland) |
| Escorez 5415 | 23.5 | Tackifying Resin supplied by |
| | | ExxonMobil (USA) |
| Irganox 1010 | 1.8 | Antioxidant supplied by BASF |
| | | (Germany) |

This Comparative Example 1 comprises, as its main polymeric component, Rextac RT2730, a Ziegler-Natta propene-butene-1 copolymer, available from Rextac (USA). This copolymer is believed to contain 36.9% by weight of butene-1 and to have a Number Average Molecular Weight Mn equal to 8,260 g/mole. Moreover Rextac RT2730 shows a Brookfield viscosity at 190° C. of 3,000 mPa·s; an Enthalpy of Crystallization from the melt, measured at Time Zero according to the method described herein, equal to 1.4 J/g; an Enthalpy of Fusion, measured again at Time Zero, of just 8.2 J/g; finally, in the DSC Fusion thermogram, still at Time Zero, Rextac RT2730 shows a main fusion peak whose Peak Temperature is as low as 53° C.

Even after five days of aging at Room Conditions (i.e. at 23° C. and 50% Relative Humidity), both the thermal and mechanical properties of this C3-C4 copolymer, with a relatively low content of butene-1 and with poor initial thermal properties, continue to show several unsatisfactory values. In fact, its overall fusion enthalpy in aged conditions after five days, is as low as 20.4 J/g with a peak temperature of the main fusion peak located only at 49.4° C. This too low fusion enthalpy and too low fusion peak temperature of Rextac RT2730 even after five days of aging greatly impair the ability of the above described adhesive of Comparative Example 1 to withstand severe shear stresses as it will be shown below. This in spite of the fact that the aged fusion enthalpy, detected over 100° C., of this copolymer is the 20.6% of its global fusion enthalpy (i.e. it is equal to 4.2 J/g); and the ratio between the fusion enthalpy, detected between 55° C. and 100° C., and the fusion enthalpy, detected over 100° C., is equal to 3.86.

Even more unsatisfactory are the mechanical properties of the copolymer Rextac RT2730, even after five days of aging at 23° C. and 50% Relative Humidity. In fact, when it is subjected, after aging for five days, to an EVF test at 45° C., according to the previously described method, it shows a tensile stress at break that is as low as 0.2 MPa; an elongation at break of just 182%; and a toughness equal only to 0.3 MJ/m³.

Rextac RT2730 has a density at 23° C. equal to 0.86 g/cm³; a Ring & Ball softening point of 110° C.; a Glass transition temperature Tg equal to −23° C. and a Needle Penetration at 23° C. as high as 30 dmm.

The adhesive formulation of Comparative Example 1 includes also 10% by weight of a second additional polymer, i.e. Licocene PP 1,602, which does not contain, among its monomers, any butene-1. It is a propene-ethene metallocene copolymer that is believed to have an ethene content of 10.9% by weight, a Number Average Molecular Weight Mn equal to 9,950 g/mole and a melt viscosity at 190° C. of 2,800 mPa·s. The presence of a minor quantity of this additional C3-C2 copolymer may help in enhancing the adhesiveness of the above hot-melt formulation as well as in fostering the potential development of a stronger crystalline structure in the main butene-1 copolymer, thanks to the faster crystallization both of polyethylene and polypropylene, whose crystals may theoretically act as nucleating agents for a possible more rapid, more robust and larger crystallization of relatively rare poly-butene-1 segments existing in the chains of the main C3-C4 copolymer Rextac RT2730.

However, with the above shown very poor basic thermal and mechanical properties of the main butene-1 copolymer Rextac RT2730, in this case even the addition of some Licocene 1602 is unable to promote any improvement in the overall very unsatisfactory behavior of this comparative hot-melt formulation when it is tested for its resistance to applied shear stresses, according to the Shear-Hang Time test illustrated above. Indeed, the adhesive formulation of Comparative Example 1 has a Shear-Hang Time at 38° C. and Time Zero (i.e. at 120 minutes from its solidification from the molten state) that has the unacceptably very low value of only 251 s; and even after five days of aging at Room Conditions, the Shear-Hang Time at 38° C. reaches the very unsatisfactory final value of just 367 s, with an absolute increase of only 116 s. With such extremely poor performances in the resistance to applied shear stresses, the formulation of this Comparative Example 1 is totally inadequate for the scopes of the present invention.

For the sake of a complete information, we can add that the hot-melt adhesive formulation of Comparative Example 1 has also a Brookfield viscosity at 190° C. equal to 1,940 mPa·s; a Ring & Ball softening temperature of 98.7° C.; a rheological melting temperature (Tx), after five days of aging at Room Conditions, measured in increasing temperature at the heating rate of 2° C./minute and at the frequency of 1 Hz, that is equal to 84.0° C.; and, again after five days of aging and with the same rheological testing set-up, an elastic modulus G′ at 38° C., of 0.35 MPa.

### Examples According to the Invention

### Example 1

The following hot-melt adhesive, according to the present invention, has been formulated by using a butene-1-propene copolymer that fully satisfies the requirements of the present invention. It has been prepared by mixing its constituents in the molten state at 170° C.:

| | % by weight | |
|---|---|---|
| | on the total | |
| | weight of | |
| | the adhesive | |
| Ingredient | formulation | Nature and supplier |
| Rextac RT2837 | 64.7 | C3-C4 Ziegler-Natta copolymer |
| | | supplied by Rextac (USA) |
| Licocene PP 1602 | 10.0 | C3-C2 metallocene copolymer |
| | | supplied by Clariant (Switzerland) |
| Escorez 5415 | 23.5 | Tackifying Resin supplied by |
| | | ExxonMobil (USA) |
| Irganox 1010 | 1.8 | Antioxidant supplied by BASF |
| | | (Germany) |

The above formulation of this Example 1 according to the present invention, exactly reproduces the already discussed adhesive formulation of Comparative Example 1, with the only difference being just the full substitution of the butene-1 copolymer Rextac RT2730, with a different butene-1 copolymer, i.e. Rextac RT2837, which, as already highlighted, fully satisfies the requirements of the present invention.

In fact, Rextac RT2837 is a Ziegler-Natta propene-butene-1 copolymer, available from Rextac (USA), that is believed to contain 41.0% by weight of butene-1; to have a Number Average Molecular Weight Mn equal to 10,450 g/mole and a Brookfield viscosity at 190° C. of 3,800 mPa·s. Rextac RT2837 exhibits also an Enthalpy of crystallization from the melt, measured at Time Zero according to the method described herein, equal to 26.9 J/g and an Enthalpy of Fusion, measured again at Time Zero, that is also equal to 26.9 J/g. Still at Time Zero, this butene-1 copolymer shows, in its DSC Fusion thermogram, a main fusion peak whose peak temperature is as high as 94.5° C.

After five days of aging at Room Conditions, i.e. at 23° C. and 50% Relative Humidity, the thermal and mechanical properties of Rextac RT2837 improve even further: in fact, its overall fusion enthalpy, after aging for five days, is at the excellent level of 40.6 J/g with a peak temperature of the main fusion peak located at the optimum level of 74.0° C. Its aged fusion enthalpy, detected over 100° C., has a sufficiently limited value of 9.7 J/g, i.e. the 23.7% of its global fusion enthalpy; and the ratio between its fusion enthalpy, detected between 55° C. and 100° C., and its fusion enthalpy, detected over 100° C., is equal to 3.2.

In a similar way Rextac RT2837 shows also very good mechanical properties. In fact after five days of aging at 23° C. and 50% Relative Humidity, when subjected to an EVF test at 45° C., according to the previously described method, Rextac RT2837 shows a tensile stress at break that has the excellent value of 20.6 MPa, with an elongation at break of as much as 1,100% and an optimum toughness equal to 13.44 MJ/m³. Moreover Rextac RT2837 has a density at 23° C. equal to 0.87 g/cm³; a Ring & Ball softening point of 115° C.; a Glass transition temperature Tg equal to-29.2° C. and a Needle Penetration of 5 dmm at 23° C. and of 19 dmm at 55° C.

With such excellent thermal and mechanical properties of its main polymeric component, i.e. the Ziegler-Natta butene-1 copolymer Rextac RT2837, the hot-melt adhesive formulation of the present Example 1 is expected to have a very good resistance even when subjected to the most challenging shear stresses. This is confirmed by the results that this formulation shows in the previously described Shear-Hang Time test. In fact, the above hot-melt adhesive formulation of Example 1 has a Shear-Hang Time at 38° C. and Time Zero (i.e. at 120 minutes from its solidification from the molten state) that has the unusually good value of as much as 1,376 s. This already excellent value of Hang-Time further significantly improves when this adhesive is allowed to age for five days at 23° C. and 50% Relative Humidity; in fact, after such aging, the hot-melt adhesive formulation of Example 1 reaches a Shear-Hang Time at 38° C. as long as 2,705 s, with an absolute increase of as many as 1,329 s and a percent increase of 96.6%.

Based on these optimal results, the hot-melt adhesive formulation of the present Example 1 is completely satisfying the requirements and scopes of the present invention.

We can also add that the hot-melt adhesive formulation of Example 1 has a Brookfield viscosity at 190° C. equal to 2,300 mPa·s; a Ring & Ball softening temperature of 106.4° C.; a rheological melting temperature (Tx), after five days of aging at Room Conditions, measured in increasing temperature at the heating rate of 2° C./minute and at the frequency of 1 Hz, that is equal to 95.5° C.; and, again after five days of aging and with the same rheological testing set-up, an elastic modulus G′ at 38° C., of 1.11 MPa.

### Example 2

The following hot-melt adhesive, according to the present invention, has been formulated by using a blend of two different butene-1 copolymers. More precisely, in this formulation of Example 2, at least one of said butene-1 copolymers (i.e. Rextac RT2837) fully satisfies the requirements of the present invention; while the second one, present in a minor quantity, i.e. Rextac RT2730, does not satisfy at all said requirements. This formulation has been prepared by mixing its constituents in the molten state at 170° C.:

| | % by weight | |
|---|---|---|
| | on the total | |
| | weight of | |
| | the adhesive | |
| Ingredient | formulation | Nature and supplier |
| Rextac RT2837 | 50.7 | C3-C4 Ziegler-Natta Copolymer |
| | | supplied by Rextac (USA) |
| Rextac RT2730 | 16.0 | C3-C4 Ziegler-Natta Copolymer |
| | | supplied by Rextac (USA) |
| Licocene PP 1602 | 8.0 | C3-C2 metallocene copolymer |
| | | supplied by Clariant (Switzerland) |
| Escorez 5415 | 23.5 | Tackifying Resin supplied by |
| | | ExxonMobil (USA) |
| Irganox 1010 | 1.8 | Antioxidant supplied by BASF |
| | | (Germany) |

This hot-melt adhesive formulation is conceptually a “combination” of the two previously illustrated formulations. It is aimed to demonstrate that, provided that a butene-1 copolymer such as Rextac RT2837 (which fully satisfies the requirements of the present invention) remains the main polymeric component of the hot-melt adhesive, it is possible to substitute a minor fraction of the basic butene-1 copolymer with another butene-1 copolymer that even does not satisfy all our requirements (in this case again Rextac RT2730) without losing at all the overall excellent resistance to applied shear stresses, or even surprisingly somehow improving it. In this case of Example 2 we substituted about one quarter of the content of Rextac RT2837 used in Example 1 (i.e. 64.7% by weight of the whole hot-melt formulation) with 16% by weight of Rextac RT2730.

The advantages for this partial substitution can be several ones; in fact, even if, as seen, butene-1-propene copolymers like Rextac RT2730 have very poor thermal and mechanical properties, however their “softer” nature and their higher content in propene may further enhance the adhesiveness of the formulation, without at all affecting and worsening the adhesive resistance to applied shear stresses, at least if this substitution remains below a maximum acceptable level of about 40% of the butene-1 polymeric component that contains a lower amount of butene-1, e.g. less than 38% by weight of C4.

The hot-melt adhesive formulation of Example 2, tested for its resistance to shear stresses with the previously described Shear-Hang Time test, shows at 38° C. and Time Zero, i.e. at 120 minutes from its solidification from the molten state, an even slightly higher value than the formulation of Example 1, reaching as much as 1,432 s, probably owing, as said, to the beneficial effect of a slightly stronger adhesiveness. This excellent result further improves when the hot-melt adhesive of Example 2 is tested for its Shear-Hang Time at 38° C. after five days of aging at 23° C. and 50% Relative Humidity. In fact, in aged conditions, the Shear-Hang Time at 38° C. of this formulation is as long as 2,970 s; i.e. it shows, versus the same parameter measured at Time Zero, an absolute increase of as much as 1,538 s i.e. a percent increase of about 107.4%.

It is therefore obvious that the hot-melt adhesive formulation of Example 2 satisfies at an optimum level the requirements and scopes of the present invention.

We can further add that the hot-melt adhesive formulation of Example 2 has a Brookfield viscosity at 190° C. equal to 2,220 mPa·s; a Ring & Ball softening temperature of 105.8° C.; a rheological melting temperature (Tx), after five days of aging at Room Conditions, measured in increasing temperature at the heating rate of 2° C./minute and at the frequency of 1 Hz, that is equal to 96.0° C.; and, again after five days of aging and with the same rheological testing set-up, an elastic modulus G′ at 38° C., of 0.86 MPa.

Although illustrated and described herein with reference to certain specific embodiments, the present invention is nevertheless not intended to be limited to the details shown. Many modifications and variations of this invention can be made without departing from its spirit and scope. The specific embodiments described herein are offered by way of example only and the invention is to be limited only by the terms of the appended claims, along with the full scope of equivalents to which such claims are entitled.

1. A hot-melt adhesive comprising from 5% to 100% by weight of at least one copolymer, said copolymer comprising butene-1 and at least another olefin selected from C2 to C12, and having:
a Number Average Molecular Weight (Mn) greater than 3,000 g/mol;
a butene-1 content not lower than 30% by weight;
a Brookfield viscosity at 190° C. of from 500 mPa·s to 100,000 mPa·s;
a Tensile Stress at Break at 45° C. and after five days of aging at Room Conditions, defined herein as 23° C. and 50% Relative Humidity, that is greater than 7 MPa;
an Elongation at Break at 45° C. and after five days of aging at Room Conditions that is greater than 800%;
an Enthalpy of Crystallization from the melt, measured at Time Zero, defined herein as at a time not exceeding 120 minutes from solidification of said copolymer from a molten state, that is lower than 60 J/g;
an Enthalpy of Fusion measured at Time Zero that is greater than 10 J/g;
a Peak Temperature of the main fusion peak measured at Time Zero that is not lower than 55° C.;
a Peak Temperature of the main fusion peak, measured after five days of aging at Room Conditions, between 55° C. and 100° C.;
a total Fusion Enthalpy, measured after five days of aging at Room Conditions, from 25 J/g to 100 J/g; and
a Fusion Enthalpy detected over 100° C., measured after five days of aging at Room Conditions, that is not greater than 49% of the total Fusion Enthalpy.

2. The hot-melt adhesive of claim 1, characterized in that the butene-1 copolymer has a Fusion Enthalpy detected over 100° C., measured after five days of aging at Room Conditions, that is not greater than 40% of the total Fusion Enthalpy.

3. The hot-melt adhesive of claim 1, characterized in that the butene-1 copolymer has a ratio between the Fusion Enthalpy, detected between 55° C. and 100° C. after five days of aging at Room Conditions, and the Fusion Enthalpy, detected over 100° C. after five days of aging at Room Conditions, that is greater than 1.

4. The hot-melt adhesive of claim 1, characterized in that the butene-1 copolymer has a butene-1 content not lower than 38% by weight.

5. The hot-melt adhesive of claim 1, characterized in that the butene-1 copolymer comprises from 25% by weight to 70% by weight of propene.

6. The hot-melt adhesive of claim 1, characterized in that the butene-1 copolymer comprises from 2% by weight to 30% by weight of ethene or of hexene.

7. The hot-melt adhesive of claim 1, characterized in that the butene-1 copolymer, shows a Toughness at 45° C. greater than 5.0 MJ/m³, said Toughness being measured after five days of aging at Room Conditions.

8. The hot-melt adhesive of claim 1, characterized in that the butene-1 copolymer has a butene-1 content ranging from 30% by weight to 60% by weight.

9. The hot-melt adhesive of claim 1, characterized in that the butene-1 copolymer is synthesized using a metallocene catalytic system.

10. The hot-melt adhesive of claim 1, characterized in that the butene-1 copolymer is synthesized using a Ziegler-Natta catalytic system.

11. The hot-melt adhesive as in claim 10, characterized in that the process of synthesizing the butene-1 copolymer is carried out in a stirred reactor under the following conditions:
at a temperature from 50° C. to 90° C. and at an absolute pressure from 1.5 MPa to 3.0 MPa;
with an average residence time of reactants inside the stirred reactor from 60 minutes to 180 minutes; and
in the presence of an electron donor in a sufficient quantity such that the molar ratio of the electron donor to the tri-alkyl-aluminum co-catalyst used in the Ziegler-Natta catalytic system is in the range from 1:100 to 1:10.

12. The hot-melt adhesive of claim 11, characterized in that the electron donor is an alkoxy-silane selected from the group consisting of cyclohexyl methyl dimethoxysilane, phenyl triethoxy silane, dimethyl diethoxy silane, dodecyl triethoxy silane, methyl phenyl diethoxy silane, dimethyl diisopropenoxy silane, methyl octyl dimethoxy silane and methyl triethoxy silane.

13. The hot-melt adhesive of claim 1, characterized in that the hot-melt adhesive further comprises from zero to 40% by weight of at least one additional homopolymer or copolymer or of a mixture thereof, said additional homopolymer or copolymer comprising less than 38% by weight of butene-1.

14. The hot-melt adhesive of claim 13, characterized in that the additional homopolymer or copolymer comprises less than 30% by weight of butene-1.

15. Hot-melt adhesive as in claim 13), characterized in that the additional homopolymer or copolymer or at least one polymer in the mixture of additional homopolymers or copolymers, comprises zero butene-1.

16. The hot-melt adhesive of claim 15, characterized in that the additional homopolymer or copolymer or at least one polymer in the mixture of additional homopolymers or copolymers, that comprises zero butene-1, is a polyolefin synthesized from alpha-olefins from C2 to C12 and their blends, or is a styrenic block copolymer.

17. The hot-melt adhesive of claim 1, characterized in that the hot-melt adhesive further comprises, as an additional component, from zero to 40% by weight of at least one homopolymer of butene-1 or a mixture of homopolymers of butene-1.

18. The hot-melt adhesive of claim 13, characterized in that the additional homopolymer or copolymer or at least one polymer in the mixture of additional homopolymers or copolymers is modified with at least one functional group selected from the group consisting of maleic anhydride, maleic acid, acrylic acid, methacrylic acid, esters of acrylic acid, esters of methacrylic acid, and vinyl acetate.

19. The hot-melt adhesive of claim 1, characterized in that the hot-melt adhesive further comprises from zero to 95% by weight of at least one tackifying resin or a mixture of tackifying resins selected from the group consisting of non-hydrogenated, partially hydrogenated or fully hydrogenated aliphatic or cycloaliphatic hydrocarbon resins; non-hydrogenated, partially hydrogenated or fully hydrogenated aromatic hydrocarbon resins; non-hydrogenated, partially hydrogenated or fully hydrogenated aliphatic/aromatic or cycloaliphatic/aromatic hydrocarbon resins; non-hydrogenated, partially hydrogenated or fully hydrogenated polyterpene or modified polyterpene resins; non-hydrogenated, partially hydrogenated or fully hydrogenated rosins and esters thereof; and mixtures thereof.

20. The hot-melt adhesive of claim 19, characterized in that the tackifying resin or the mixture of tackifying resins has a Ring & Ball softening temperature from 5° C. to 160° C.

21. The hot-melt adhesive of claim 20, characterized in that the tackifying resin or the mixture of tackifying resins has a Ring & Ball softening temperature not lower than 110° C.

22. The hot-melt adhesive of claim 1, characterized in that the hot-melt adhesive further comprises from zero to 40% by weight of at least one liquid or semi-solid plasticizer or of a mixture of liquid or semi-solid plasticizers selected from the group consisting of:
paraffinic mineral oils or naphthenic mineral oils and mixtures thereof; liquid or semi-solid paraffinic and naphthenic hydrocarbons, and mixtures thereof; liquid or semi-solid oligomers and polymers of polyolefins from C2 to C20 and liquid or semi-solid co-oligomers and copolymers thereof; liquid or semi-solid plasticizers selected from the group consisting of phthalates, benzoates, sebacates, citrates, tartrates; vegetable oils; liquid or semi-solid natural and synthetic fats; and mixtures thereof.

23. The hot-melt adhesive of claim 1, characterized in that the hot-melt adhesive further comprises from zero to 15% by weight of at least one wax or of a mixture of waxes.

24. The hot-melt adhesive of claim 23, characterized in that the wax or at least one wax in the mixture of waxes is a polyolefinic wax that comprises more than 50% by mole of ethene or of propene and which is modified with maleic anhydride.

25. The hot-melt adhesive as in claim 1, characterized in that the hot-melt adhesive comprises between zero and 10% by weight of at least one stabilizer selected from anti-oxidants, anti-UV photo-stabilizers and mixtures thereof.

26. The hot-melt adhesive of claim 1, characterized in that the hot-melt adhesive further comprises between zero and 10% by weight of at least one additional component selected from the group consisting of mineral fillers, pigments, dyes, perfumes, surfactants, antistatic agents and mixtures thereof.

27. The hot-melt adhesive of claim 1, characterized in that the hot-melt adhesive has a Brookfield viscosity at 190° C. not greater than 20,000 mPa·s.

28. The hot-melt adhesive of claim 1, characterized in that the hot-melt adhesive has a Ring & Ball softening temperature not higher than 135° C.

29. The hot-melt adhesive of claim 1, characterized in that, after five days of aging at Room Conditions, the hot-melt adhesive has a Rheological Melting Temperature that is not lower than 80° C.

30. The hot-melt adhesive of claim 1, characterized in that, after five days of aging at Room Conditions, the hot-melt adhesive has an Elastic Modulus G′ at 38° C. that is not lower than 0.5 MPa.

31. The hot-melt adhesive of claim 1, characterized in that the hot-melt adhesive has a Shear-Hang Time at 38° C. not lower than 900 seconds, measured after five days of aging at Room Conditions.

32. The hot-melt adhesive of claim 1, characterized in that the hot-melt adhesive shows a percentage increase between its Shear-Hang Time at 38° C. measured after 120 minutes from a solidification of said hot-melt adhesive from a molten state, and its Shear-Hang Time at 38° C. measured after five days of aging at Room Conditions, which is not lower than 10%.

33. The hot-melt adhesive of claim 1, characterized in that the hot-melt adhesive shows an increase between its Shear-Hang Time at 38° C. measured after 120 minutes from a solidification of said hot-melt adhesive from a molten state, and its Shear-Hang Time at 38° C. measured after five days of aging at Room Conditions, which in absolute value is not lower than 300 seconds.

34. A bonded structure, comprising:
a first substrate;
a second substrate; and
the hot-melt adhesive of claim 1,
wherein said hot-melt adhesive adheres the first substrate to the second substrate, and
wherein said hot-melt adhesive, when applied at a basis weight from 0.5 g/m² to 50 g/m², gives to the bonded structure a Peel Strength, measured after five days of aging at Room Conditions, greater than 0.25 N per 50 mm width.

35. The bonded structure according to claim 34, characterized in that at least one of the first substrate or the second substrate is a porous substrate, a fibrous substrate, or a perforated film having either a bidimensional or tridimensional structure.

36. A hygienic absorbent article comprising the bonded structure of claim 34.

37. A hygienic absorbent article comprising the hot-melt adhesive of claim 1.

38. The hygienic absorbent article of claim 37, wherein the hygienic absorbent article is a baby-diaper, a training pant diaper, a diaper for incontinent adults, or an absorbent article for feminine hygiene.

39. The hygienic absorbent article according to claim 38, wherein the hot-melt adhesive is: i) a general construction adhesive for the whole of the hygienic absorbent article; ii) an elastic bonding adhesive for bonding elastic components; iii) a core-stabilizing adhesive for strengthening and ensuring a structural integrity of an absorbent core of the absorbent hygienic article; iv) a non-woven bonding adhesive for bonding nonwoven components with another nonwoven component or with a plastic film; or v) a perforated film bonding adhesive for bonding perforated films having either bidimensional or tridimensional structures.

40. An article comprising the hot-melt adhesive of claim 1, wherein said article is an absorbent surgical mattress or sheet or a surgery laminate for medical use or a wound-dressing product.

41. An article comprising the hot-melt adhesive of claim 1, wherein said article is a mattress or a component thereof.

42. An article comprising the hot-melt adhesive of claim 1, wherein said article is an automotive component or a component used as a part of a vehicle.

43. An article comprising the hot-melt adhesive of claim 1, wherein said article is a package.
